(19) United States
(12) Patent Application Publication
(10) Pub. No.: US 2024/0327025 A1
(43) Pub. Date: Oct. 3, 2024

(54) HYDROGEN SUPPLY UNIT FOR AN AIRCRAFT, METHOD OF SUPPLYING LIQUID HYDROGEN IN AN AIRCRAFT, AND AIRCRAFT

(71) Applicant: Airbus Operations GmbH, HAMBURG (DE)

(72) Inventor: Kai SCHULZE-REIMANN, HAMBURG (DE)

(21) Appl. No.: 18/619,730

(22) Filed: Mar. 28, 2024

(30) Foreign Application Priority Data
Mar. 31, 2023 (EP) 23166095.2

(51) Int. Cl. B64D 37/30; B64D 37/20

(52) U.S. Cl. CPC B64D 37/30; B64D 37/20

(57) ABSTRACT

A hydrogen supply unit for an aircraft comprises a tank for storing liquid hydrogen, an extraction chamber provided in the tank with one or more openings for extracting the liquid hydrogen from the tank through the extraction chamber, at least one line connected to the extraction chamber and configured for supplying the liquid hydrogen to a consumer of the aircraft, and at least one pump connected to the line. Two or more such extraction chambers may be provided, wherein each extraction chamber is connected to an assigned valve which is connected to a control unit configured for opening and closing the valves depending on attitudes and accelerations of the aircraft.

### CROSS-REFERENCES TO RELATED APPLICATIONS

This application claims the benefit of European Patent Application Number 23 166 095.2 filed on Mar. 31, 2023, the entire disclosure of which is incorporated herein by way of reference.

### FIELD OF THE INVENTION

The invention relates to a hydrogen supply unit for an aircraft. Further, the invention relates to a method of supplying liquid hydrogen in an aircraft. In addition, the invention relates to an aircraft.

In particular, the invention can be applied in aircrafts such as airplanes, helicopters and other objects that can fly.

### BACKGROUND OF THE INVENTION

Gas emissions having an impact on the climate have to be reduced.

Particularly in aviation, a switch from conventional gas turbine engines to propulsion systems based on hydrogen (H2) has been identified as a growing market with a high number of aeroplanes in the next years and decades, in order to achieve zero emission flights. Many research institutes and companies have been searching for viable propulsion architectures to eliminate or reduce aircraft emissions for regional and larger aircrafts. In such aircrafts, the hydrogen is provided as liquid hydrogen (LH2) in a tank within the aircraft and supplied via pipes to the aircraft's propulsion engine and/or other consumer units of the aircraft.

When supplying the LH2 to the aircraft's propulsion or other consumer unit, accidental feeding of the pipes with gaseous H2 (GH2) in the tank needs to be avoided. Further, the amount of unusable LH2 remaining in the tank after a maximum LH2 extraction shall be minimized.

### SUMMARY OF THE INVENTION

Therefore, it is an object of the invention to maximize utilization of the LH2 provided in an LH2 tank of an aircraft, and to prevent ingestion of gaseous hydrogen when liquid hydrogen from the tank is supplied to a consumer unit in the aircraft.

According to a first aspect, the invention provides a hydrogen supply unit for an aircraft, comprising a tank for storing liquid hydrogen, an extraction chamber provided in the tank and comprising one or more openings for extracting the liquid hydrogen from the tank through the extraction chamber, at least one line connected to the extraction chamber and configured for supplying the liquid hydrogen to a consumer unit of the aircraft, and at least one pump connected to the line.

Preferably, the extraction chamber is attached to a wall of the tank surrounding the hydrogen.

Preferably, the openings are provided in the bottom of the extraction chamber.

Preferably, the extraction chamber is mounted on or near the bottom or bottom wall of the tank so that the openings are close to the bottom of the tank.

Preferably, two or more such extraction chambers are provided in the tank, wherein each extraction chamber is connected to an assigned valve.

Preferably, each valve is connected to a control unit configured for opening and closing the valves depending on attitudes and accelerations of the aircraft.

Preferably, the control unit is configured for receiving data from the air data inertial reference system (ADIRS) of an aircraft in order to control the valves.

Preferably, each valve is provided in the respective line connected to the assigned extraction chamber.

Preferably, at least one extraction chamber is located in a rear section of the tank.

Preferably, at least one extraction chamber is located in a front section of the tank.

Preferably, at least one extraction chamber is mounted at or near the ceiling of the tank.

Preferably, at least a pair of extraction chambers is mounted at or near the ceiling of the tank, one of them being located in a rear section of the tank and one being located in a front section of the tank.

Preferably, one or more lines or pipes extend from the one or more extraction chambers through an aft outlet provided in a rear section or end of the tank and/or through a forward outlet provided in a front section or front end of the tank.

Preferably, one or more lines extend from the one or more extraction chambers exclusively through an aft outlet provided in a rear section or rear end of the tank.

Preferably, one or more lines extend from the one or more extraction chambers exclusively through a forward outlet provided in a front section or front end of the tank.

Preferably, the one or more pumps are configured for being positioned in the aircraft below and/or behind the aft outlet of the tank.

Preferably, the one or more pumps are configured for being positioned below and/or in front of the forward outlet of the tank.

According to a second aspect, the invention provides a method of supplying liquid hydrogen in an aircraft, comprising the steps: extracting liquid hydrogen from a tank of an aircraft through at least one extraction chamber provided in the tank and attached to an inner wall of the tank; and supplying the liquid hydrogen from the extraction chamber to a consumer unit of the aircraft.

Preferably, the liquid hydrogen is extracted at different extracting positions which are selected depending on current attitudes and accelerations of the aircraft.

Preferably, the hydrogen supply unit according to the invention is used when the method is performed.

According to a third aspect, the invention provides an aircraft, characterized by a hydrogen supply unit according to the invention.

Characteristics and advantages described in relation to the hydrogen supply unit are also related to the method of supplying liquid hydrogen, and vice versa.

### BRIEF DESCRIPTION OF THE DRAWINGS

In the following, exemplary embodiments of the invention showing further characteristics and advantages are described in detail with reference to the figures, in which:

FIG. 1 shows a hydrogen supply unit according to a first preferred embodiment of the invention as a schematic sectional view; and

FIG. 2 shows a hydrogen supply unit according to a second preferred embodiment of the invention as a schematic sectional view.

### DETAILED DESCRIPTION OF THE PREFERRED EMBODIMENTS

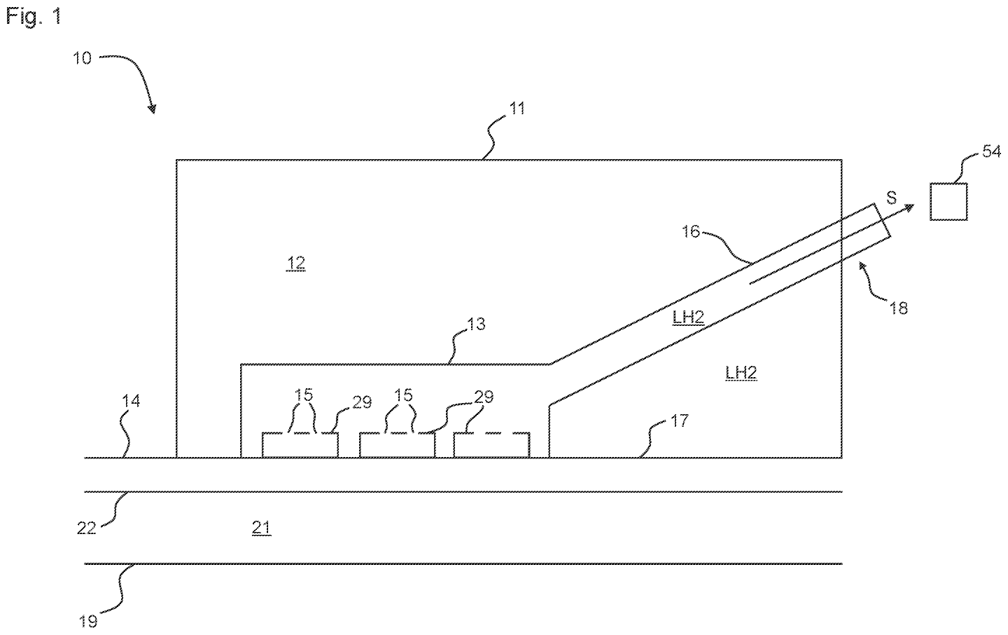

FIG. 1 shows a hydrogen supply unit 10 according to a first preferred embodiment of the invention. The hydrogen supply unit 10 comprises a tank 11 which is configured to store in its interior 12 hydrogen (H2) in liquid state, i.e., as liquid hydrogen (LH2). In the tank 11, an extraction chamber 13 is provided, which comprises at least one opening 15 or preferably a number of openings 15. The openings 15 are provided for extracting the liquid hydrogen from the interior 12 of tank 11 through the extraction chamber 13.

At least one line or pipe 16 is connected to the extraction chamber 13 inside tank 11. It is configured for supplying the liquid hydrogen or LH2 from the tank 11 to a consumer unit 54 of the aircraft, for example to a propulsion unit, as indicated by arrow S in the figure.

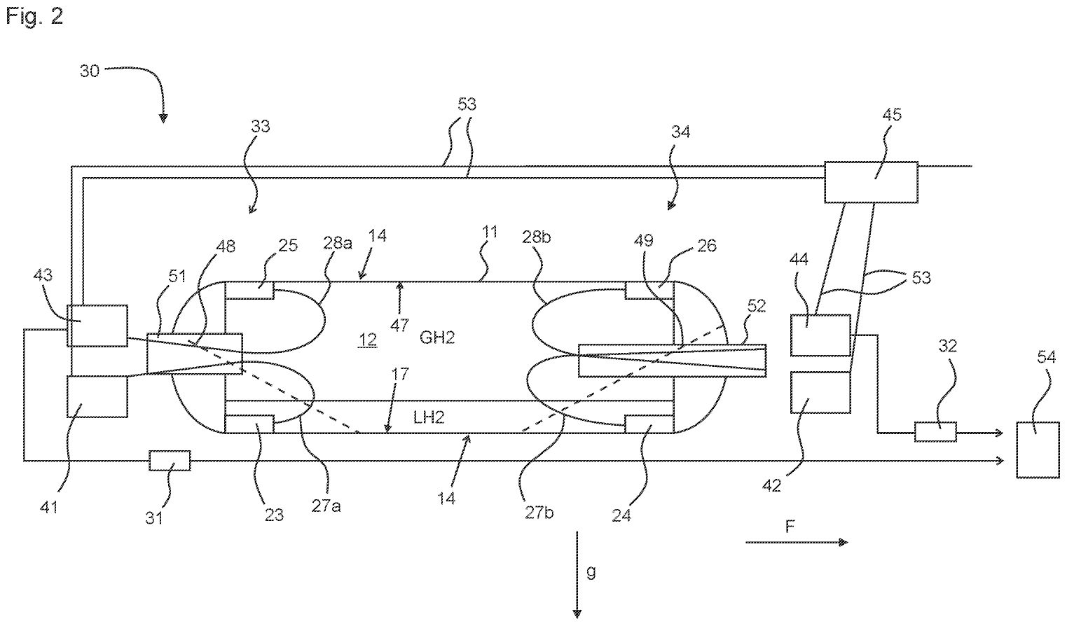

The hydrogen supply unit 10 e.g. comprises at least one pump connected to line 16. The pump may for example be arranged in the hydrogen supply unit 10 like or similarly to pump 31 or pump 32 shown in FIG. 2 which is described in detail further below.

The extraction chamber 13 is attached to a wall 14 of tank 11, which is an inner tank wall in this example. The extraction chamber 13 may e.g. be configured as an extraction pod. It is preferably welded to the inner tank wall 14 or installed by other means close to the wall 14.

In this example, extraction chamber 13 is mounted at or near the bottom 17 of tank 11 and positioned in a way that the openings 15 of extraction chamber 13 are located near or close above the bottom 17 of tank 11. The bottom 17 is formed by the inner side of the wall 14.

In particular, the openings 15 of extraction chamber 13 are formed in a lower wall 29 of extraction chamber 13. The openings 15 are flat and positioned with a very small distance from to the bottom 17 formed by inner wall 14 of tank 11, in order to be as close as possible to a flush installation. That means, the openings 15 are located at a very low height above wall 14 of the tank 11. In particular, the openings 15 of extraction chamber 13, or pod, may have the same surface area as line or pipe 16, in order to not produce an additional drag during LH2 extraction. The openings 15 are e.g. formed as slits.

The line or pipe 16 connected to extraction chamber 13 extends through an outlet 18 provided in tank 11, which is preferably remotely located from the position where the extraction chamber 13 is installed. Preferably, the outlet 18 is located at a forward end of the tank and/or at an aft end of tank 11, as it will be explained as an example further below with reference to FIG. 2. Pipe 16 may e.g. further extend to a coldfinger.

Several such extraction chambers 13 may be installed in a similar manner within the interior 12 of tank 11.

In addition to inner tank wall 14, the structure of tank 11 comprises an outer tank wall 19 in order to provide a vacuum layer 21 between the inner tank wall and the outer tank wall 19. A multilayer insulation (MLI) 22 is preferably installed between the inner tank wall 14 and the outer tank wall 19.

Referring to FIG. 2 now, a hydrogen supply unit 30 according to a second preferred embodiment of the invention will be described. It may comprise a number of extraction chambers in a tank as described above.

Also in this exemplary embodiment, the hydrogen supply unit 10 comprises a tank 11 which is configured for storing hydrogen, in particular liquid hydrogen (LH2), in the interior 12 of tank 11. Tank 11 may e.g., be configured as described above with reference to FIG. 1.

A number of extraction chambers 23, 24, 25, 26 are provided in tank 11, each comprising one or more openings 15 for extracting the liquid hydrogen from the tank 11 through the respective extraction chamber, as described above with reference to FIG. 1. The extraction chambers 23-26 are attached to the inner wall 14 of the tank 11 which surrounds its interior 12.

Each extraction chamber 23, 24, 25, 26 is connected to an associated line 27a, 27b, 28a, 28b for supplying the liquid hydrogen (LH2) to the consumer unit 54 of the aircraft which is equipped with hydrogen supply unit 10. Each line 27a, 27b, 28a, 28b extending from the respective extraction chamber 23, 24, 25, 26 is connected via an assigned valve 41, 42, 43, 44 to a pump 31 or 32.

The hydrogen supply unit 10 is configured for being mounted in an aircraft. The forward direction of the aircraft and of tank 11 is indicated by arrow F.

Tank 11 comprises a rear or aft section 33 and a front or forward section 34 in accordance with the forward direction F of the aircraft in which the hydrogen supply unit 10 is mounted.

All extraction chambers 23 to 26 are installed or welded to tank wall 14 which surrounds the interior 12 of the tank 11 in which the hydrogen is stored.

In this preferred embodiment of the invention, one pair 23, 24 of the extraction chambers is mounted on or near the bottom 17 of tank 11 formed by its lower wall 17, so that the respective openings 15 of the extraction chambers 23, 24 are as close as possible to the lower tank wall 17 to allow extraction of the liquid hydrogen from there. In this way, these extraction chambers or pods 23, 24 form lower extraction chambers.

In particular, the openings 15 are provided in the bottom 29 of the respective extraction chamber 23, 24, which is formed its lower wall. The openings are preferably provided in a way that they are facing the bottom wall 17 of tank 11, as described above with reference to FIG. 1.

Advantageously, the lower extraction chamber 23 is positioned in the rear section 33 of tank 11, while the other lower extraction chamber 24 is positioned in the front section 34 of tank 11.

Both extraction chambers 23, 24 are connected via their associated line 27a, 27b to their assigned valve 41 and 42 respectively, which are opened and closed during operation according to actual attitudes and accelerations of the aircraft.

In addition to the lower extraction chambers 23, 24, at least one further extraction chamber 25, 26 or pair of extraction chambers 25 and 26, may be mounted at or near the ceiling 47 of tank 11. The extraction chambers or pods 25, 26 thus form upper extraction chambers.

The upper extraction chamber 25 may be positioned in the rear section 33 of tank 11, while the other upper extraction chamber 26 may be positioned in the front section 34 of tank 11.

Both extraction chambers 25, 26 are connected via their respective line 28a, 28b to their assigned valve 43 and 44 respectively, which are opened and closed during operation according to current attitudes and accelerations of the aircraft.

A control unit 45 formed by a logics box is connected to the valves 41-44 by signal or data connections 53. The control unit 45 is configured for opening and closing the valves 41 to 44 depending on the current attitudes and accelerations of the aircraft in which the hydrogen supply unit 30 is provided. During operation, the logics box 45 receives the attitudes and accelerations of the aircraft via a data connection to the ADIRS (Air Data Inertial Reference System) of the aircraft. That means, the control unit or logics box 45 is configured for receiving data from the ADIRS in order to control the valves 41 to 44 depending on the received attitude and acceleration data.

As shown in FIG. 2, a portion of the hydrogen within tank 11 is liquid hydrogen (LH2) and another portion of the hydrogen is gaseous hydrogen (GH2), wherein the GH2 is usually above the LH2. When the aircraft and thus also tank 11 is in horizontal orientation, the liquid hydrogen LH2 within tank 11 usually covers the lower extraction chambers or extraction pods 23, 24 mounted on or near the bottom 17 of tank 11.

In this situation, the valves 41, 42 connected to the lines 27a, 27b extending from the lower extraction chambers 23, 24 covered by LH2 are opened according to the acceleration and attitude data received by control unit 45 from the ADIRS.

As an example, a method of supplying liquid hydrogen in an aircraft is described in more detail the following with reference to FIGS. 1 and 2.

Liquid hydrogen LH2 stored in tank 11 is extracted through at least one extraction chamber 13, 23, 24, 25, 26 provided in the tank 11 and attached to inner wall 14 of the tank. The extracted liquid hydrogen LH2 is supplied via at least one line 16, 27a, 27b, 28a, 28b and one or more pumps 31, 32 connected thereto from the one or more extraction chambers to a consumer unit 54 of the aircraft.

If two or more extraction chambers are provided in tank 11, the liquid hydrogen is preferably extracted at the different extraction positions where the extraction chambers 13, 23, 24, 25, 26 are located. The extraction positions in the tank 11 are varied or selected depending on the current attitude an acceleration of the aircraft.

For example, if the aircraft is on the ground or in horizontal orientation and not accelerated, the liquid hydrogen contained in tank 11 covers the extraction chambers 23, 24 installed at the bottom 17 of tank 11. In this case, the valves 41, 42 assigned to extraction chambers 23 and 24 respectively, which are mounted at or near the bottom or lower wall 17 of tank 11, are opened, while the valves 43, 44 assigned to extraction chambers 25 and 26 respectively, which are mounted at or near the ceiling or upper wall 47 of tank 11, are closed and thus avoid an extraction of the gaseous hydrogen GH2 above the liquid hydrogen LH2 from the tank 11.

When the aircraft is climbing and/or accelerated, it may happen depending on the amount of liquid hydrogen in the tank 11, that only the extraction chamber 23 provided in the rear section 33 of tank 11 is covered by the liquid hydrogen LH2, as depicted in FIG. 2 by the LH2 surface 48. All other extraction chambers 24 to 26 are surrounded by gaseous hydrogen GH2 in that situation.

In this case, only the valve 41 assigned to the rear lower extraction chamber 23 is opened, while the other valves 42, 43 and 44 are closed. Thus, only the liquid hydrogen LH2 in tank 11 will be supplied to the consumer unit 54 of the aircraft.

When the aircraft is descending or is accelerating negatively, it may happen depending on the amount of LH2 in tank 11, that only the lower extraction chamber 24 located at or near the bottom 17 of tank 11 in its front section 34 is covered with liquid hydrogen, as indicated by LH2 surface 49 in FIG. 2. In this situation, all other extraction chambers 23, 25, 26 are surrounded by gaseous hydrogen GH2. In this case, only valve 42 associated to the front lower extraction chamber 24 is opened, while all other valves 41, 43 and 44 are closed. Thus, only the liquid hydrogen LH2 in tank 11 will be supplied to the consumer unit 54 of the aircraft.

Optionally, as described above, one or more extraction chambers 25, 26 may be mounted near or at the ceiling 47 of tank 11.

In this case, when an acceleration opposite to gravitational acceleration g is acting on the aircraft and on the tank 11 mounted therein, it may happen that one or more of the upper extraction chambers 25, 26 installed at or near the ceiling 47 of tank 11 are surrounded by the liquid hydrogen LH2, while the lower extraction chambers 23, 24 mounted at or near bottom 17 are surrounded by the gaseous hydrogen GH2. In this case, only the valve or valves 43, 44 connected to the upper extraction chamber or chambers 25, 26 are opened.

That means, that even for a longer period of an acceleration acting on the aircraft which is opposite to the gravitational acceleration g, liquid hydrogen can be extracted as the extraction chambers or pods 25 and/or 26 positioned on or near the ceiling 47 can be used.

In particular, the hydrogen supply unit 10 as shown in FIG. 2 with extraction chambers at different positions within tank 11 allow extraction in any aircraft attitude.

As shown in FIG. 2, tank 11 comprises a first outlet 51 in its rear or aft section 33, and a second outlet 52 in its front or forward section 34. Thus, the first outlet 51 forms a rear or aft outlet, and the second outlet 52 forms a front of forward outlet.

In particular, the outlets 51, 52 extend through polar mounts provided in the forward section 34 and the aft section 33 of tank 11. This allows a higher static pressure at the pumps 31, 32 than with an outlet only in the front section 34.

The aft pump 31 is preferably positioned below and most preferably also behind the aft outlet 51 of tank 11. The front or forward pump 32 is preferably positioned below and most preferably further forward than the forward outlet 34 of tank 11.

A specific advantage of this arrangement is that for example with the aircraft in climb, the aft outlet 51 is activated or can be activated, wherein the aft pump 31 is well below the tank 11. Thus, the hydrogen's static pressure supports the pump operation. This is especially supportive during TOGA (Take-Off/Go-Around) conditions, where the aircraft raises its angle of attack to get more lift.

According to another embodiment which is not shown in the figures, the tank 11 comprises only the forward outlet 52 as a single outlet, and all piping or lines 27, 28 are guided through that single forward outlet 52. In this case, there is no aft tank outlet, but the different positions of the extraction chambers 23-26 are kept as described above, in this example four positions. This configuration reduces the amount of pump head or static pressure. However, the specific advantage is that the number of throughputs in the tank 11 are reduced.

As an alternative, the complete equipment comprising the pumps 31, 32 and/or the valves 41-44 is installed in the aft of the aircraft to raise the static pressure, as the aft or rear installation of the equipment is more helpful with a positive angle of attack, where the most pump performance and mass flow is needed. In this case all piping or lines 27, 28 are guided through the single aft or rear outlet 51.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMBERS

10, 30 hydrogen supply unit
11 tank
12 interior of tank
13 extraction chamber or pod
14 inner wall of tank
15 openings
16 line/pipe
17 bottom or lower wall of tank
18 outlet
19 outer tank wall
21 vacuum layer
22 multilayer insulation/MLI
23, 24 lower extraction chambers
25, 26 upper extraction chambers
27a, 27b lines or pipes
28a, 28b lines or pipes
29 bottom or lower wall of extraction chamber
31 aft pump
32 forward pump
33 rear or aft section of tank
34 front or forward section of tank
LH2 liquid hydrogen
GH2 gaseous hydrogen
41, 42 valves
43, 44 valves
45 control unit/logics box
47 ceiling of tank
48 LH2 surface when aircraft is climbing
49 LH2 surface when aircraft is descending
51 rear or aft outlet
52 front or forward outlet
53 signal connections
54 consumer unit
F forward direction of the aircraft
g gravitational acceleration

1. A hydrogen supply unit for an aircraft, comprising:
a tank configured to store liquid hydrogen,
an extraction chamber provided in the tank and comprising one or more openings for extracting the liquid hydrogen from the tank through the extraction chamber,
at least one line connected to the extraction chamber and configured for supplying the liquid hydrogen to a consumer of the aircraft, and
at least one pump connected to the at least one line.

2. The hydrogen supply unit according to claim 1, wherein the one or more openings are provided in a bottom of the extraction chamber, and
wherein the extraction chamber is mounted on or near the bottom of the tank so that the one or more openings are proximate the bottom of the tank.

3. The hydrogen supply unit according to claim 1, wherein two or more extraction chambers are provided, wherein each extraction chamber is connected to a valve, each valve being connected to a control unit configured for opening and closing the valves depending on attitudes and accelerations of the aircraft.

4. The hydrogen supply unit according to claim 1, wherein at least one extraction chamber is located in a rear section of the tank, and at least one extraction chamber is located in a front section of the tank; or
at least one extraction chamber is mounted at or proximate a ceiling of the tank; or
at least a pair of extraction chambers is mounted at or proximate a ceiling of the tank, one of the extraction chambers of the pair of extraction chambers located in a rear section of the tank and the other of the extraction chambers of the pair of extraction chambers located in a front section of the tank; or
any combination thereof.

5. The hydrogen supply unit according to claim 1, wherein the at least one line extends from the extraction chamber through an aft outlet provided in a rear section or end of the tank, or through a forward outlet provided in a front section or end of the tank, or both; and or exclusively through an aft outlet provided in a rear section or end of the tank; or
exclusively through a forward outlet provided in a front section or end of the tank;
or any combination thereof.

6. The hydrogen supply unit according to claim 5, wherein the at least one pump is positioned in the aircraft:
below, or behind, or below and behind the aft outlet of the tank; or
below, or in front, or below and in front of the forward outlet of the tank; or
any combination thereof.

7. A method of supplying liquid hydrogen in an aircraft, comprising the steps:
extracting liquid hydrogen from a tank of an aircraft through at least one extraction chamber provided in the tank and attached to an inner wall of the tank, and,
supplying the liquid hydrogen from the at least one extraction chamber to a consumer of the aircraft.

8. The method according to claim 7, wherein the liquid hydrogen is extracted at different extracting positions which are selected depending on current attitudes and accelerations of the aircraft.

9. The method according to claim 7, wherein a hydrogen supply unit is provided for extracting liquid hydrogen, wherein the at least one extraction chamber comprises one or more openings, and
wherein the hydrogen supply unit comprises
at least one line connected to the at least one extraction chamber and configured for supplying the liquid hydrogen to the consumer of the aircraft, and
at least one pump connected to the at least one line.

10. An aircraft comprising:
the hydrogen supply unit according to claim 1.
